(19) United States
(12) Patent Application Publication
(10) Pub. No.: US 2014/0278819 A1
(43) Pub. Date: Sep. 18, 2014

(54) Alternate Scenario Analysis for Project Management

(71) Applicant: Professional Project Services, Inc., Oak Ridge, TN (US)

(72) Inventors: Philip Tyson Ramsey, Knoxville, TN (US); Philip Dale Ramsey, Oak Ridge, TN (US); Nathan J. Sloan, Seymour, TN (US); William R. Musick, JR., Knoxville, TN (US); Matthew Cody Lambert, Lenoir City, TN (US)

(73) Assignee: PROFESSIONAL PROJECT SERVICES, INC., Oak Ridge, TN (US)

(21) Appl. No.: 14/025,369

(22) Filed: Sep. 12, 2013

Related U.S. Application Data
(60) Provisional application No. 61/785,078, filed on Mar. 14, 2013.

(51) Int. Cl. G06Q 10/06

(52) U.S. Cl. CPC G06Q 10/06375
USPC 705/7.37

(57) ABSTRACT

A system for generating and analyzing alternate project management scenarios at a high level, or a “What If Tool” (WIT) System. The WIT System enhances project management tools by providing simple and reversible scenario generation, analysis, and comparison for complex projects and portfolios. The WIT System imports and transforms the project management information from an external project management tool into collections at a user-defined level while retaining relevant constraints and relationships. The WIT System allows the user to generate and compare alternate constraint and timeline scenarios at a high level without involving all detailed elements of the original project management information, which is often time and cost prohibitive. The differences between scenarios may be visualized and reported to enhance the decision making process. The WIT System also allows the original project management information to be updated based on a scenario.

### BACKGROUND

On-site management of a project requires a significant level of detail to successfully manage the day-to-day execution. Proper planning and management involves breaking the project down into and monitoring execution of low level (e.g., day-to-day or hour-to-hour) activities to ensure the project remains on schedule and within budget. Each project or portfolio has detailed schedules that contain the detail activities, resources, and workflows necessary to for effective management.

Conventional project management tools used to plan and monitor projects include general purpose software applications (e.g., a spreadsheet application) facilitating management of small or simple projects, dedicated project management software applications facilitating management of small or simple projects to large or complex projects, and project portfolio management software suites (e.g., Oracle Primavera P6) facilitating management of small or simple projects to large or complex portfolios of large or complex projects. A large or complex project may have thousands of activities involving multiple resources (e.g., dollars, materials, engineers, or craft) each with their own project logic or workflow (i.e., relationships) and a portfolio may include tens to hundreds of projects.

Organizations managing projects and/or project portfolios of projects frequently experience changing constraints that affect the planning and implementation of a portfolio, project, or portion thereof. Any project may have some level of interdependency with one or more other projects such that changing constraints (e.g., funding, manpower, limitations, craft, or timelines) may impact other projects. When adjustments to project constraints are made, the detailed schedules of the interdependent projects are evaluated and recalculated. In other words, changing project constraints in a large or complex project often requires recalculation of thousands of activities in view of the associated resources and relationships which is a time consuming process. If the altered project constraint causes the project to fall behind schedule and/or go over budget, finding a viable solution to bring the project back into compliance involves making one or more strategic modifications, each requiring additional recalculations of the project(s).

While detailed information down to the activity level is critical for day-to-day project management, it far exceeds that which is necessary for an enterprise-level manager to manage the strategic planning and evaluation of the portfolios in a timely and cost effective manner. It is with respect to these and other considerations that the present invention has been made.

### BRIEF SUMMARY

Various embodiments of a system for analyzing alternate project management scenarios at an executive or management level, or a “What If Tool” (WIT) System, and accompanying method enhance project management tools working at the activity level by providing simple and reversible scenario generation, analysis, and comparison for complex projects and portfolios. The WIT System imports and transforms the project management information from an external project management tool into collections at a user-defined level while retaining relevant constraints and relationships. The WIT System allows the user to generate and compare alternate constraint and timeline scenarios at a high level without involving all detailed elements of the original project management information, which is often time and cost prohibitive. The differences between scenarios may be visualized and reported to enhance the decision making process. The WIT System also allows the original project management information to be updated based on a scenario.

A detail project used by conventional project management tools often contains large amounts of data used to manage the outcome of the project such as the tasks that must be performed in order to achieve the desired outcome, the resources allocated for each task, and the logical relationships between the tasks. Within the hierarchical breakdown of a detail project, the project management data objects are grouped into hierarchical levels representing any of the various levels at which tasks are organized and hierarchical groups representing a collection of project management data objects at a selected hierarchical level which may have subordinate objects.

The WIT System begins operation by importing the detail resource and schedule data from an external project management tool into the WIT database. The WIT System provides the user with the capability to transform large amounts of detailed project data into collections at higher levels. The transformed project management information serves as the baseline WIT Source corresponding to the original external project management information. The baseline WIT Source may be manipulated via the manipulate module to adjust the priorities and schedules of projects to address resource limitations and constraint changes in a timely manner while still allowing access to the lowest-level information contained in the detailed schedules and ensuring the pedigree of the detail project data is maintained. In other words, the WIT Source may be used to generate and evaluate various “what if” scenarios allowing the user to visualize the cost and schedule impacts at a higher level (e.g., enterprise management) without requiring evaluation and/or recalculation of all of the detailed project data needed for day-to-day project management found in the external project management information created by or used by the external project management tool. Each scenario represents a set of changes made to the baseline WIT Source.

In various embodiments, the WIT System performs an import operation for importing project management information from an external project management tool, a transform operation for transforming the imported project management information into the high level project management information utilized by the WIT System, a manipulate operation for manipulating the transformed project management information into alternate constraint and timeline scenarios, a visualization operation for visualizing scenarios and reporting differences between scenarios, and an export operation for updating the original external project management information to match a selected scenario.

The transformation operation begins with an aggregation operation that aggregates the detail schedule logic, schedule, milestones, and time-phased resource data into collections at a hierarchical level selected from the hierarchical breakdown with the same time-phasing contained in the imported project management information. In various embodiments, the aggregation operation transforms the imported project management information (at the activity level) by recalculating schedule logic, constraints, and milestones, and then aggregating resources at the working level to create a WIT Source, which can then be manipulated to create scenarios and perform “what if” analysis. In various embodiments, a WIT grouping operation establishes the user-specified WIT Groups to allow the imported project management information to be organized through filtering, sorting, charting, etc. An optional linking operation links the reference data to the imported project management information.

In embodiments of the aggregation operation, tasks from the detail project are grouped into collections. In one embodiment, the individual tasks from the detail project are aggregated into temporal collections. The temporal collections represent each working time unit between the start and end dates of the scenario serving as placeholders for resources. Resources are assigned to the corresponding temporal collection based on their distribution in the detail project. Milestones are assigned to their respective working level groups and to the appropriate timeline column based on the due date. An offset date is also calculated in relation to the start or end date of the corresponding working level, depending on the milestone type to ensure that milestone due dates are accurately represented.

The relationship assignment operation establishes working level relationships between the working level groups in each working level collection based on the underlying logic relationships of the detail project. The working level relationships are then evaluated to ensure the logic relationships are not violated. If related activities belong to the same working level group, the logical link between the two is classified as an internal relationship. Internal relationships remain intact as the working level group is moved through time and may be disregarded in scenario evaluations at the working level. All other relationships are identified as dynamic relationships. In the case of a dynamic relationship, the WIT System creates a virtual relationship between working level groups that corresponds to the original relationship between the linked activities grouped in different working level groups. The virtual relationships between working level groups take the place of the activity level relationships from the external project management information when manipulating the WIT Source. If the virtual relationships restrict the start dates of the working level groups from changing in relation to each other (i.e., a circular relationship), the relative scheduling of those working level groups is locked. Locked working level groups are only allowed to be moved along the timeline in unison when calculating scenarios.

The timelines and constraints of the WIT Source may be manipulated to define alternate scenarios for analysis. The outcome of the scenario is calculated in terms of one or more selected parameters and operates on the working level groups and working level group relationships. In other words, the calculation operation occurs above the activity level significantly reducing the number of calculations involved in evaluating a scenario. A scenario visualization operation displays visualizations of the scenario outcome via the user interface.

Because the WIT System aggregates (i.e., rolls up) the tasks and activities below the selected working level into working level groups that are treated as a single task, the number of calculations involved in calculating the outcome of a scenario is reduced. Reducing the number of calculations directly and, often, significantly affects the amount of time needed to analyze each scenario. In other words, the WIT System allows the user to make, generate, and analyze multiple scenarios for a project within the amount of time required to calculate a single outcome of the project using a conventional project management tool. Thus, the WIT System allows management to consider and make informed and timely decisions based on more scenarios than would be readily available from a conventional project management tool. The lower time investment also gives the user greater ability to try scenarios with uncertain outcomes. Further, the ability to store and recall the original scenario as well as any alternate scenario is beneficial when making decisions and/or documenting the decision making process.

### BRIEF DESCRIPTION OF THE DRAWINGS

Further features, aspects, and advantages of the invention represented by the embodiments described present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 is a conceptual hierarchical breakdown of a detail project illustrating the hierarchical levels within a detailed schedule hierarchy;

FIG. 2 illustrates one embodiment of the high level architecture and external interfaces of the WIT System;

FIG. 3 illustrates one embodiment of the high level architecture of the WIT System;

FIG. 4 is a data flow diagram that illustrates the relationships between project management information, WIT Sources, and user-defined scenarios;

FIG. 5 illustrates one embodiment of a high level flowchart illustrating the overall process of the WIT System;

FIG. 6 is a flowchart of one embodiment of the import operation;

FIG. 7 is a flowchart of one embodiment of the transform operation;

FIG. 8 is a flowchart of one embodiment of the aggregate operation;

FIG. 9A-9C are conceptual illustrations of one embodiment of imported project management information as it is transformed by the WIT System from the detailed project management information used by a conventional project management tool to the uniform, high level project management information used by the WIT System for scenario generation and analysis;

FIG. 10 is a flowchart of one embodiment of the manipulate operation;

FIG. 11 is a flowchart of one embodiment of the report operation;

FIG. 12 is a flowchart of one embodiment of the export operation;

FIG. 13 illustrates a screenshot of the WIT System's user interface;

FIGS. 14A and 14B illustrate sample reports generated by the WIT System; and

FIG. 15 illustrates an exemplary architecture of a computing device suitable to implement aspects of the present disclosure.

### DETAILED DESCRIPTION

A system for analyzing alternate project management scenarios at an executive or management level, or a “What If Tool” (WIT) System, and accompanying method is described herein and illustrated in the accompanying figures. The WIT System enhances project management tools working at the activity level by providing simple and reversible scenario generation, analysis, and comparison for complex projects and portfolios. The WIT System imports and transforms the project management information from an external project management tool into collections at a user-defined level while retaining relevant constraints and relationships. The WIT System allows the user to generate and compare alternate constraint and timeline scenarios at a high level without involving all detailed elements of the original project management information, which is often time and cost prohibitive. The differences between scenarios may be visualized and reported to enhance the decision making process. The WIT System also allows the original project management information to be updated based on a scenario.

A detail project used by conventional project management tools often contains large amounts of data used to manage the outcome of the project. More specifically, the detail project includes all of the tasks that must be performed in order to achieve the desired outcome, the resources allocated for each task, and the logical relationships between the tasks. While the various tasks in the detail project are generally distinguished using different names based on the hierarchical level of the task, as used herein, the term “task” refers to any activity or collection of activities in the detail project. In other words, a task may represent a project (i.e., a large task), a subproject, a detailed schedule, a single activity, or any other collection of activities. Each task may have a logical relationship with one or more other tasks. Examples of logical relationships include, but are not limited to, finish-to-start, start-to-start, start-to-finish, finish-to-finish relationships.

FIG. 1 is a tree diagram showing a conceptual hierarchical breakdown of a detail project used by project management tools working with detailed schedules at low levels. The hierarchical breakdown may be applied to most any high level project management data object (e.g., a portfolio, a project, or a detailed schedule) having subordinate tasks. Different types of hierarchical breakdowns are available to show the different types hierarchies for various project management data objects. For example, a hierarchical breakdown may show the distribution of resources between various organizational units (e.g., an organizational breakdown structure) or the tasks required to complete an objective (e.g., a work breakdown structure).

Within the hierarchical breakdown, the project management data objects are grouped into hierarchical levels. For purposes of this discussion, a “hierarchical level” is any of the various levels at which tasks are organized and a “hierarchical group” represents a collection of objects (e.g., tasks, resources, locations, or organizational units) at a selected hierarchical level which may have subordinate objects. A hierarchical breakdown may contain any number of hierarchical levels. Any particular hierarchical level may contain any number of hierarchical groups, and any hierarchical group may contain any number of hierarchical subgroups. A hierarchical subgroup is a subset of a hierarchical grouping. Regardless of the number of hierarchical levels that are used to assemble the hierarchical groups, the lowest hierarchical level of each branch of the hierarchical breakdown is referred to as the activity level.

In the illustrated hierarchical breakdown, the dashed boxes represent hierarchical levels 1 through N, where N is the lowest hierarchical level in the hierarchical breakdown, and the outline numbered boxes represent hierarchical groups, where X with a subscript corresponding to the hierarchical level represents any number of hierarchical subgroups of a hierarchical group at a given hierarchical level. In the illustrated embodiment, hierarchical group 1 makes up hierarchical level 1; hierarchical groups 1.1, 1.2, 1.3, and 1.X₂ makes up hierarchical level 2; and so forth. The lower hierarchical levels (e.g., levels 3 through N) may represent hierarchical subgroups or activities associated with a hierarchical group.

FIG. 2 illustrates one embodiment of the WIT System operating in a network computing environment. The WIT System 200 includes the WIT application 202 running on an application server 204. In various embodiments, the WIT application is in communication via a network 206 with a project management server 208 or other suitable computing device running an external project management tool 210 (e.g., a conventional project management tool) and a data server 212 running a database management system 214 or other suitable computing device for storing project management information created by or used by the WIT application and/or the external project management tool (i.e., external project management information). In various embodiments, a user 216 remotely accesses one or more of the WIT application, the project management application, and the database management system over the network using a client device 218 though a user agent 220. Examples of suitable networks include, but are not limited to, a personal area networks, local area networks, wide area networks, the Internet, and combinations thereof. In some embodiments, a single computing device serves as one or more of the application server, the project management server, and the data server. In some embodiments, some or all of the WIT application, the external project management tool, and the database management system run on the same computing device. In some embodiments, the WIT application is accessed locally rather than with a client device and/or user agent.

The WIT System 200 maintains various data stores including, but not limited to, a projects data store 222 and scenarios data store 224. In various embodiments, the projects data store 222 may contain, but is not limited, one or more of static reference data, imported project management information obtained from the external project management tool, and transformed project management information transformed by the WIT System. Scenarios generated with the WIT System are stored in the scenarios data store 224.

FIG. 3 is a block diagram of one embodiment of a high level architecture of the WIT application 202. In various embodiments, the WIT application 202 includes a user interface 302, a security module 314, an administration module 316, a reference module 318, an import module 320, a transform module 322, a manipulate module 324, a report module 326, and an export module 328.

The user interface 302 provides textual, graphical, and, optionally, audible outputs from various output devices (e.g., video displays, printers, and speakers) and accepts inputs from various input devices (e.g., a keyboard, mouse, touch screen, or microphone) allowing the user 216 to interact with the other modules of the WIT application 202. The input devices and output devices may be local (i.e., at the WIT application server) or remote (i.e., at the client device). In various embodiments, the user interface 302 includes one or more interface types including, but not limited to, menu, form, point-and-click, drag-and-drop, touch, gesture, voice recognition, and natural user interfaces. For example, the user interface 302 may be implemented via hypertext markup language (HTML) or extensible markup language (XML) documents displayable by the user agent (e.g., a web browser) running on the client device. The HTML or XML documents may be served to the client device from the WIT application server. In another embodiment, the user interface is displayed by a WIT client application (i.e., the user agent) running on the client device and communicating with the primary WIT application. In another embodiment, the user interface is provided by the WIT application on the local computing device or on the client device through a terminal. The user interface is involved in various aspects of the WIT System including, but not limited to, selecting a source of project management information for importing; selecting a working time unit and working level(s); assigning milestones and relationships; defining, visualizing, and refining scenarios; selecting scenarios to report; and selecting scenarios to export.

The security module 314 restricts access to some (i.e., a subset) or all of the functionality and/or data of the WIT application 202. In various embodiments, the restrictions are based on roles or permissions assigned to the user.

The administration module 316 controls authorization and access to the WIT application 202. In one embodiment, an administrator may maintain project management and scenario information, add or delete users 216, update the role or permissions associated with users or functionality, and configure external connections (e.g., creating and/or authorizing links to and connections from other systems and applications including, but not limited to, selected client devices, database management servers, selected databases, external project management tools, and project management servers).

The reference module 318 allows the user 216 to link reference data from the database management system 214 or other authorized source with the imported project management information or the transformed project management information. In various embodiments, the reference data is linked when the imported project management information is transformed. Examples of reference data include, but are not limited to, original project schedules, maps, videos, pictures, audio files, multimedia images, and other static data.

FIG. 4 is a data flow diagram of one embodiment of the WIT System showing the relationships between external project management information, WIT Source, and user-defined scenarios. Data flow begins with importing the detail resource and schedule data from the external project management tool into the WIT database. In various embodiments, the external project management information is stored in an electronic format directly or indirectly accessible by the WIT application. For example, the external project management information may be stored in an application specific database or file or a general application or system file (e.g., a spreadsheet or comma separated value document) that may be loaded or queried by the WIT application. In other embodiments, some or all of the external project management information may be stored in a non-electronic format (e.g., printed reports or handwritten information) that cannot be directly accessed by the WIT application and require user involvement to input the external project management information. As used herein, importing broadly encompasses, without limitation, loading, importing, access via an interface such as an application program interface (API), manual entry, optical recognition of scanned reports or other images (and any associated training), and other techniques for entering or transferring data to the WIT System.

The external project management information is owned by the data owner. The data owner may be an organization with a large portfolio or program of projects and have one or more users 216 responsible for making important decisions or performing analysis of detailed schedule data for the data owner. Examples of typical users include, but are not limited to, officers, executives, managers, employees, contractors, and auditors.

The WIT System provides the user (e.g., enterprise management) with the capability to transform large amounts of detailed (i.e., low level) project data into collections at a higher level. The transformed project management information serves as the baseline WIT Source corresponding to the original external project management information. The baseline WIT Source may be manipulated via the manipulate module 324 to adjust the priorities and schedules of projects to address resource limitations and constraint changes in a timely manner while still allowing access to the lowest-level information contained in the detailed schedules and ensuring the pedigree of the detail project data is maintained. In other words, the WIT Source may be used to generate and evaluate various “what if” scenarios allowing the user to visualize the cost and schedule impacts at a higher level (e.g., enterprise management) without requiring evaluation and/or recalculation of all of the detailed project data needed for day-to-day project management found in the external project management information created by or used by the external project management tool. Each scenario represents a set of changes made to the baseline WIT Source. Once transformed, the WIT Source is stored for reference and modification. Similarly, scenarios may be saved for review, comparison, and/or use in creating additional scenarios. Each scenario created via the manipulate module 324 is traceable back to the original WIT Source on which the scenario is based.

The WIT Source allows configuration control between a WIT Source and the imported project management information, as well as between a WIT Source and a user-defined scenario. The WIT Source may include, but is not limited to, a source name, contact information, titles, timeline data, WIT Groups, relationships, escalation rates, milestones, and resource distributions. Timeline data may include, but is not limited to, timeline values such as dollars spread, resources, resources types, start dates, funding, risk, waste, and labor. WIT Groups may include, but are not limited to, projects sorted into groups or group types and options for grouping projects. Relationships may include, but are not limited to, how tasks or projects interact with each other, relationship offset data that provides a timeline unit for correlation, and information relating to correlating projects, such as start-to-finish, finish-to-start, start-to-start, and finish-to-finish data. Escalation rates may include, but are not limited to, a table of rates to be applied to each timeline unit, for example fiscal year or quarter. Milestones may include, but are not limited to, milestones to be used as an alert if the moving of a project causes the milestone to be missed. Resource distributions may include, but are not limited to, information related to how resources are distributed, for example, whether even, escalated, even until a certain date, or other user definable method.

FIG. 5 is a high level flowchart illustrating one embodiment of a method of utilizing the WIT System. The high level operations of the method 500 include an import operation 510 for importing project management information from an external project management tool, a transform operation 520 for transforming the imported project management information into the high level project management information utilized by the WIT System, a manipulate operation 530 for manipulating the transformed project management information into alternate constraint and timeline scenarios, a visualization operation 540 for visualizing scenarios and reporting differences between scenarios, and an export operation 550 for updating the original external project management information to match a selected scenario.

FIG. 6 is a high level flowchart of the sub-operations of one embodiment of the import operation. The import operation 510 begins with a source selection operation 610 that provides a user interface 302 allowing the user 216 to provide detailed project management information to the system. In various embodiments, the detailed project management information is obtained from an external project management tool 210. The external project management tool 210 may be a single system or multiple systems. The user 216 may select some (e.g., a subset) or all external project management information.

Following the source selection operation 610, a retrieval operation 620 retrieves the detail project from the selected source. Project management information is always imported at the activity level. In one embodiment, retrieval of the detail project may be accomplished via multiple queries executed directly against the external project management tool 210. For example, the project management information may be obtained directly from a database maintained by the external project management tool using an API offered by the external project management tool provider. In some embodiments, the external project management information is exported from the external project management tool in an intermediate format that can be imported by the WIT System. In other embodiments, some or all of the project management information created and/or used by the external project management tool is in a non-electronic format that cannot be directly accessed by the WIT application. Embodiments of the WIT system retrieve such external project management information by providing a user interface, which allows the user to manually enter or scan a detail project from printed or handwritten documents.

The detail project storage operation 630 stores the detailed project management information in a form accessible by the WIT System for use in generating the WIT Source. In various embodiments, the detailed project management information is stored within the projects data store 222 of the WIT System.

FIG. 7 is a high level flowchart of the sub-operations of one embodiment of the transformation operation that transforms the imported project management information into the WIT Source used for scenario creation and analysis. The transformation operation begins with an aggregation operation 710 that aggregates the detail schedule logic, schedule, milestones, and time-phased resource data into collections at a hierarchical level selected from the hierarchical breakdown with the same time-phasing contained in the imported project management information.

In various embodiments, the aggregation operation 710 transforms the imported project management information (at the activity level) by recalculating schedule logic, constraints, and milestones, and then aggregating resources at the working level to create a WIT Source, which can then be manipulated to create scenarios and perform “what if” analysis. To incorporate the inter-project relationships, the WIT System creates these relationships based upon the inter-project detail relationships such that overall schedule relationships between projects are maintained.

Following the aggregation operation 710, a WIT Source storage operation 720 optionally stores the WIT Source for future retrieval and use. In one embodiment, the system automatically initiates the WIT Source storage operation 720 upon completion of the aggregation operation 710. In other embodiments, the WIT Source storage operation 720 is manually initiated by the user after completion of the aggregation operation 710.

Next, a WIT grouping operation 730 establishes the user-specified WIT Groups to allow for reporting scenarios. Establishing WIT Groups allows the imported project management information to be organized through filtering, sorting, charting, etc. In various embodiments, the activities are organized into WIT Groups based on one or more selected features. Examples of suitable features for establishing WIT Groups include, but are not limited to, funding source, location, and activity type. For example, when grouping on activity type, the activities may be grouped into tearing down a building or cleaning out the building. By grouping the activities, the WIT Source allows identification of which WIT Groups are utilizing the significant amounts of the available resources (e.g., money or workforce). Furthermore, the WIT Groups are generally customizable by the customer to create a plurality of different charts. In other embodiments, WIT Groups may be established for project titles, project groups, project group types, project relationships, milestones, and risk, among others.

Finally, a linking operation 740 links the reference data to the imported project management information. In various embodiments, a user 216 interacts with the user interface 302 to link static reference data contained in the projects data source 222 to the WIT Source.

FIG. 8 is a flowchart of the sub-operations of one embodiment of the aggregation operation. During the aggregation operation 710, tasks from the detail project are grouped into collections. In one embodiment, the individual tasks from the detail project are aggregated into timeline columns or other temporal collections. The configuration operation 810 sets the working time unit and one or more working levels for the aggregated WIT Source. The working time unit is typically a larger unit such as a month, quarter, or year. The working level is a selected hierarchical level of the imported project management information that can be manipulated while maintaining the underlying logic relationships of the detail project management information. The working level may be applied uniformly to the imported project management information. In various embodiments, the working time unit and the working level are selected by the user 216. The timeline creation operation 820 creates temporal collections (e.g., timeline columns) representing each working time unit between the start and end dates of the scenario to serve as placeholders for resources.

In various embodiments, individual (e.g., multiple, contiguous) working levels may be selected for different hierarchical groups (i.e., branches) of the imported project management information. This allows the user 216 to manipulate tasks (i.e., rolling up or drilling down) within any of the individual working levels while manipulating scenarios via the manipulate module 324. Working with individual working levels provides greater flexibility for schedule optimization, while limiting data requirements to only what is deemed necessary by the user 216. When individual working levels are selected, a multi-level scenario is created by the manipulate module 324.

The resource distribution operation 830 assigns the resources into the corresponding temporal collection based on their distribution in the detail project, which ensures the integrity of the imported project management information. In various embodiments, the resource aggregation operation 830 creates a resource element for each temporal collection corresponding to one or more resources. Examples of resources include, but are not limited to, funding, labor hours, personnel, equipment, and other consumable quantities. A resource value for each time container is determined by a selected distribution and based upon a selected calendar. Examples of distributions used in determining resource values include, but are not limited to linear, triangular, trapezoidal, bell stepped, double peak, and back-loaded distributions.

The milestone assignment operation 840 assigns milestones to their respective working level groups and to the appropriate temporal collection based on the due date. An offset date is also calculated in relation to the start or end date of the corresponding working level, depending on the milestone type to ensure that milestone due dates are accurately represented.

The relationship assignment operation 850 establishes working level relationships between the working level groups in each working level collection based on the underlying logic relationships of the detail project. The relationships may include all of the available relationship types as are included in the imported project management information. The working level relationships are then evaluated to ensure the logic relationships are not violated.

The relationship classification operation 860 evaluates the logical links between each activity in a working level group and its succeeding activity. If the activities belong to the same working level group, the logical link between the two is classified as an internal relationship (i.e., static relationship). The internally related activities will move uniformly along with any movement of the working level group containing the activities. The movement of one working level group will not affect any other working level group; therefore, no other working level group movements are required. The internal relationships remain intact as the working level group is moved through time and may be disregarded in scenario evaluations at the working level by disregard relationship operation 870. In various embodiments, any working level relationship classified as an internal relationship is marked allowing it to be ignored when calculating the outcome of a scenario. In other embodiments, any working level relationship classified as an internal relationship is discarded during the disregard internal relationship operation.

All other relationships are identified as dynamic relationships. In the case of a dynamic relationship, the create virtual relationships operation 875 creates a virtual relationship between the working level groups containing the linked activities. Each virtual relationship is an intergroup relationship that corresponds to the original relationship between activities grouped into different working level groups. The relationship type, lag, and a reference to the succeeding working level group are saved as properties of the working level relationship. The relationship type of a working level relationship is determined from the type of logical relationship tie of the original imported project management information. Creating a virtual relationship to the succeeding working level group links both working level groups; therefore, any movement of either working level group can affect the other, depending on the relationship type and lag properties. For example, a working level relationship might have a relationship type of finish-to-start and a lag of two years meaning the succeeding working level group could not begin until two years after the activities associated with the initial working level group were completed.

The virtual relationships between working level groups take the place of the activity level dynamic relationships from the external project management information when manipulating the WIT Source. If a scenario moves the initial working level group, the succeeding working level group will be moved as the outcome of the scenario is calculated if its start date occurs within two years of the new finish date of initial working level group under the scenario. The user interface 302 may indicate if/when a milestone is exceeded as the working level groups are moved in time. Examples of virtual relationships include, but are not limited to, finish-to-start, start-to-start, start-to-finish, finish-to-finish, and locked relationships.

Valid schedules may result in circular relationships when aggregated to a working level. Circular relationships occur when a working level group has working level relationships to one or more other working level groups that restrict the start dates of the working level groups from changing in relation to each other. In a circular relationship identification operation 880, the transform module identifies circular relationships between working level groups. When a circular relationship is identified, a lock relationship operation 890 marks the working level groups as locked together for purposes of relative scheduling. Locked working level groups are only allowed to be moved along the timeline in unison when calculating scenarios.

In one embodiment, the processing of operations 820 through 890 is performed by the transform module 322 at the lowest selected working level. Start/end delta values for each task are maintained at each working level. Working level relationships are maintained at each working level. When the start and/or end date of a task is modified, all working level relationships are checked for violations. If the move does not violate any working level relationships, it is successful and each lower hierarchical level is modified by the date offset. The start and/or end dates of higher working levels are revised as necessary if the resulting dates extend beyond their start and/or end dates.

FIG. 9A illustrates a conceptual example of a detail project showing the hierarchical groups (i.e., tasks) broken down to the activity level and relationships between the activities. In the illustrated embodiment, hierarchical groups 1.1 and 1.2 exist at hierarchical level 2 and are not further subdivided; therefore, the activities (e.g., A1.1.1 through A1.1.4 for hierarchical group 1.1 and A1.2.1 through 1.2.5 for hierarchical group 1.2) associated with these working level groups are at hierarchical level 3. Hierarchical group 1.3 is subdivided into subgroups 1.3.1 through 1.3.3, which exist at hierarchical level 3 and are not subdivided; therefore, the activities associated with hierarchical group 1.3 exist at hierarchical level 4. The internal relationships between the activities in each hierarchical group are represented by the connecting arrows. The dynamic relationships between activities belonging to different hierarchical groups are represented by stars A-E.

FIG. 9B illustrates the aggregation of the activities from FIG. 9A into working level groups at the selected working level as the WIT Source is created. In this example, hierarchical level 2 has been selected as the working level for hierarchical groups 1.1 and 1.2 and hierarchical level 3 has been selected as the working level for hierarchical group 1.3. The transform module 322 aggregates the imported project management information from the hierarchical levels below the working level for each working level group. In this example, the activities at hierarchical level 3 are aggregated into working level groups G1.1 and G1.2 and the activities at hierarchical level 4 are aggregated into working level groups G1.3.1 to G1.3.3. The dynamic relationships between activities belonging to different working level groups are represented by stars A-E and are equivalent to the relationships between activities belonging to different hierarchical groups shown in FIG. 9A.

FIG. 9C illustrates the relationship assignments made as the WIT Source is created. The dashed boxes represent the activities that are aggregated into a working level group and ignored during recalculation. The dashed arrows represent internal relationships of the working groups that are ignored during recalculation. Virtual relationships between working level groups created in the WIT Source are represented by arrows A-E and correspond to the dynamic relationships represented by stars A-E in FIG. 9B. Although the dynamic relationships are not represented in FIG. 9C, none of the information about the dynamic relationships is lost. The virtual relationships include the working time units or temporal offsets required to maintain the relative schedules between the working level groups as originally specified by the corresponding relationship between the linked activities. The WIT Source of FIG. 9C has five groups and five relationships that must be evaluated and/or recalculated when constraints change compared to 17 activities and 15 relationships in the external project management information of FIG. 9A.

FIG. 10 is a high level flowchart of the sub-operations of one embodiment of the manipulate operation. The manipulate operation 530 begins with the WIT Source selection operation 1010 in which a user interface is provided allowing the user to select a WIT Source to manipulate. In one embodiment, the WIT Source selection operation 1010 the user selects which WIT Source will serve as the initial scenario.

In a scenario definition operation 1020, the system accepts inputs from the user to define a scenario. In one embodiment, the user 216 configures constraints on limited resources such as funding limits, available man hours, or other resource constraints. For example, one option allows the user 216 to evenly distribute the constraint across all the years of the project. A second option might allow the user 216 to evenly distribute the constraint until a specified date, such as a milestone date. In another embodiment, the user 216 may establish escalation rates for the time-phased distribution of resources. In yet another embodiment, the user 216 may set resource balance sensitivities for use during visualization of the scenario.

The calculation operation 1030 calculates the outcome of the scenario in terms of one or more selected parameters and operates on the working level groups and working level group relationships. In other words, the calculation operation 1030 occurs above the activity level significantly reducing the number of calculations involved in evaluating a scenario. Examples of the scenario outcome parameters calculated by the calculation operation 1030 include, but are not limited to, available dates, totals of resource allocation per working time unit, effects of updated projects, missed milestones, level of effort, and escalation.

A scenario visualization operation 1040 displays visualizations of the scenario outcome via the user interface 302. In one embodiment, the scenario visualization operation 1040 renders a timeline, relationships, and missed milestones. In another embodiment, the scenario visualization operation 1040 displays an indicator at the top of each column on the user interface based on the outcome of the scenario. The indicator may be configured to present a red indication if the resource balance is over budget and a green if the resource balance is less than or equal to the budget. The indicator may also be configured to present a yellow indication if the resource balance falls within the user-defined sensitivity limits set in the scenario definition operation 1020. The user interface 302 may also provide the user 216 with resulting textual and graphical output and provide visual alerts or indications, which may indicate, for example, that a timeline adjustment affects a project milestone. The user interface 302 may also be configured to display resource totals, including displaying the resource totals by specified groups. FIG. 13 illustrates one embodiment of a screenshot of the user interface displaying manipulated project management information.

A revise operation 1050 makes revisions to the transformed project management information. In one embodiment, the revise operation 1050 involves altering the start dates of projects. In another embodiment, multiple scenarios for a given WIT Source with varying manipulations may be created by the user 216 and compared for identifying optimal schedules and resource allocation. Any scenario may optionally be saved by the user 216 for later retrieval.

FIG. 11 is a high level flowchart of the sub-operations of one embodiment of the report operation 540 performed by the report module 326. The report option includes a select scenarios operation 1110 allowing the user to choose the scenario that serves as the basis for the visualization. A select WIT Groups operation 1120 allows the user to choose the groupings included in or used to organize the visualization. A select resources operation 1130 allows the user to choose the resources included in the visualization. A select report type operation 1140 allows the user to choose the type of report produced by the report module. Examples of report types generated by the WIT System include, but are not limited to, tables, charts, and graphs. Finally, a generate report operation 1150 visualizes the report to a selected output device for consumption by the user. FIGS. 14A and 14B illustrate embodiments of reports generated by the report module of the WIT System. Specifically, FIG. 14A is a bar graph for “Budget by Year” and FIG. 14B is a line graph depicting “Site Risk Profile.”

FIG. 12 is a high level flowchart of the sub-operations of one embodiment of the export operation performed by the export module 328. The export operation allows the changes created using the manipulate module 324 and stored in the scenarios data store 224 to be reincorporated into the external project management information utilized by the external project management tool 210. The export operation begins with a target select operation 1210 allowing the user to select the external project management data to update via the user interface 302. In various embodiments, the target select operation 1210 operates on the active scenario. In other embodiments, the target select operation 1210 allows the user to select the scenario to export via the user interface 302. Next, a difference calculation operation 1220 evaluates the differences between the selected scenario and the imported project management information. An update operation 1230 uses the differences to modify the corresponding values of the detail project in the external project management information utilized by the external project management tool 210. For example, in one embodiment, the difference calculation operation 1220 calculates offsets between the scenario schedule start dates and the original start date captured in the project data store 222, and the update operation 1230 uses the offsets to update the schedule dates in the external project management information. In various embodiments, the update operation 1230 modifies the external project management information by directly modifying the external project management information in the external project management tool via an API. In other embodiments, the update operation 1230 clones the original external project management information, modifies the cloned information, and replaces the original external project management information with the cloned information.

The following example illustrates the operation, usage, and various benefits of the WIT System in the context of an organization with a portfolio that includes projects for environmental restoration for three buildings. Initially, the portfolio has budgeted constraints for $ 100 million per year and 5,000 work hours for environmental restoration of the three buildings on the site, which includes monitoring, demolition, soil removal, and restoration. The schedule of the original scenario is for environmental remediation of all three buildings in year one (the removal of the first building at the first site, then starting remediation for the first site and starting the removal of the second building at a second site, then starting remediation for the second site and starting the removal of the third building at a third site and remediation for the third site).

During the first year, the budget for the environmental restoration decreases from $ 100 million to $75 million. To determine which of the projects and activities are still feasible due to the changing constraints, the initial scenario must be modified. In this case, the user is interested in assessing the effects of changes to the project at a high level intended to bring the project back within budget. In other words, the user is not interested in the day-to-day administration of the project. Because the budgetary change is significant, the user wants to analyze the project on an annual basis and at a level where task completion is measured in months. Using the WIT System, the detail schedule of activities is imported and transformed to create the base scenario with a working time unit of one year and a suitable high working level. Visualizing the base scenario with the WIT System after applying the new budget constraint of $75 million shows that the project is over budget for one or more years.

Utilizing the WIT System, the user alters the base scenario to create an alternate scenario in which the environmental restoration work for buildings one and two occurs during the first year and the environmental restoration work for building three occurs during the second year.

The WIT System then calculates outcomes for the alternate scenario and displays selected visualizations of the scenario allowing the user to see useful information such as whether the project is within or over budget for each year. The visualizations also provide indications of the effect of the schedule change on work force, milestones, and other resources. Thus, the WIT System scenarios enhance the decision making process based on the information in the visualizations and reports for the proposed changes to the portfolio. For example, by changing the schedule for removal of a building the workforce resource may decrease indicating a need for a layoff of excess workers. In another example, the schedule change may indicate that certain milestones will not be reached in the desired timeframe.

If the portfolio is still over budget, alternative potential scenarios for bringing the project back within budget are available, or the client or the organization's management does not like any of the scenarios, the user can generate additional scenarios as desired. For example, the user may generate a scenario which delays the soil remediation associated with the building one into year two or a scenario that delays one building into year two and another building into year three. Each scenario may be visualized using the WIT System and stored for later review.

The user may compare the outcomes of different scenarios using the WIT System to quickly assess the relative advantages and disadvantages of the scenarios. For example, the user may end up with multiple viable scenarios that bring the project back within budget. Using the WIT System to compare the scenarios allows the user to find the scenario that has the shortest timeline, uses the least resources, provides the optimal resource allocation, or meets some other desirable criteria.

Because the WIT System aggregates (i.e., rolls up) the tasks and activities below the selected working level into working level groups that are treated as a single task, the number of calculations involved in calculating the outcome of a scenario is reduced. Reducing the number of calculations directly and, often, significantly affects the amount of time needed to analyze each scenario. In other words, the WIT System allows the user to make, generate, and analyze multiple scenarios for a project within the amount of time required to calculate a single outcome of the project using a conventional project management tool. Thus, the WIT System allows management to consider and make informed and timely decisions based on more scenarios than would be readily available from a conventional project management tool. The lower time investment also gives the user greater ability to try scenarios with uncertain outcomes. Further, the ability to store and recall the original scenario as well as any alternate scenario is beneficial when making decisions and/or documenting the decision making process.

FIG. 15 is a block diagram of an exemplary architecture of a computing device that can be used to implement aspects of the present disclosure. The illustrated computing device can be used to execute the operating system, application programs, and software modules (including the software engines) described herein.

The computing device 1510 includes, in some embodiments, at least one processing device 1580, such as a central processing unit (CPU). A variety of processing devices are available from a variety of manufacturers, for example, Intel or Advanced Micro Devices. In this example, the computing device 1510 also includes a system memory 1582, and a system bus 1584 that couples various system components including the system memory 1582 to the processing device 1580. The system bus 1584 is one of any number of types of bus structures including a memory bus, or memory controller; a peripheral bus; and a local bus using any of a variety of bus architectures.

Examples of computing devices suitable for the computing device 1510 include a desktop computer, a laptop computer, a tablet computer, a mobile computing device (such as a smart phone, a tablet device, or other mobile devices), or other devices configured to process digital instructions.

The system memory 1582 includes read only memory 1586 and random access memory 1588. A basic input/output system 1590 containing the basic routines that act to transfer information within computing device 1510, such as during start up, is typically stored in the read only memory 1586.

The computing device 1510 also includes a secondary storage device 1592 in some embodiments, such as a hard disk drive, for storing digital data. The secondary storage device 1592 is connected to the system bus 1584 by a secondary storage interface 1594. The secondary storage devices 1592 and their associated computer readable media provide nonvolatile storage of computer readable instructions (including application programs and program modules), data structures, and other data for the computing device 1510.

Although the exemplary environment described herein employs a hard disk drive as a secondary storage device, other types of computer readable media are used in other embodiments. Examples of these other types of computer readable media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable media can include local storage or cloud-based storage.

A number of program modules can be stored in secondary storage device 1592 or memory 1582, including an operating system 1596, one or more application programs 1598, other program modules 1500 (such as the software engines described herein), and program data 1502. The computing device 1510 can utilize any suitable operating system, such as Microsoft Windows™, Google Chrome™, Apple OS, and any other operating system suitable for a computing device. Other examples can include Microsoft, Google, or Apple operating systems, or any other suitable operating system used in tablet computing devices.

In some embodiments, a user provides inputs to the computing device 1510 through one or more input devices 1504. Examples of input devices 1504 include a keyboard 1506, mouse 1508, microphone 1510, and touch sensor 1512 (such as a touchpad or touch sensitive display). Other embodiments include other input devices 1504. The input devices are often connected to the processing device 1580 through an input/output interface 1514 that is coupled to the system bus 1584. These input devices 1504 can be connected by any number of input/output interfaces, such as a parallel port, serial port, game port, or a universal serial bus. Wireless communication between input devices and the user interface 1514 is possible as well, and includes infrared, BLUETOOTH® wireless technology, 802.11a/b/g/n, cellular, or other radio frequency communication systems in some possible embodiments.

In this example embodiment, a display device 1516, such as a monitor, liquid crystal display device, projector, or touch sensitive display device, is also connected to the system bus 1584 via an interface, such as a video adapter 1518. In addition to the display device 1516, the computing device 1510 can include various other peripheral devices (not shown), such as speakers or a printer.

When used in a local area networking environment or a wide area networking environment (such as the Internet), the computing device 1510 is typically connected to the network 1512 through a network interface 1520, such as an Ethernet interface. Other possible embodiments use other communication devices. For example, some embodiments of the computing device 1510 include a modem for communicating across the network.

The computing device 1510 typically includes at least some form of computer readable media. Computer readable media includes any available devices and other articles of manufacture that can be accessed by the computing device 1510. Computer readable media includes volatile and nonvolatile, removable and non-removable media implemented in any device configured to store information such as computer readable instructions, data structures, program modules, or other data. Computer readable media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1510. Computer readable media is intended to cover.

The computing device 1510 may also include at least some form of computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 15 is also an example of programmable electronics, which may include one or more such computing devices, and when multiple computing devices are included, such computing devices can be coupled together with a suitable data communication network so as to collectively perform the various functions, methods, or operations disclosed herein.

Embodiments, for example, are described above with reference to flowcharts and/or operational illustrations of methods, systems, and computer program products according to embodiments. The functions/acts noted in the blocks may occur out of the order as shown in any flowchart or described herein with reference to the Figures. For example, two processes shown or described in succession may in fact be executed substantially concurrently or the blocks may sometimes be executed in the reverse order, depending upon the functionality/acts involved. While certain embodiments have been described, other embodiments may exist. Furthermore, although embodiments have been described as being associated with data stored in memory and other storage mediums, data may be stored on or read from other types of computer-readable media, such as secondary storage devices, like hard disks, floppy disks, a CD-ROM, or other forms of RAM or ROM. Further, the disclosed processes may be modified in any manner, including by reordering and/or inserting or deleting a step or process, without departing from the embodiments.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for generating project scenarios and calculating scenario outcomes above the activity level of a project, the method comprising the acts of:
importing detailed project management information, the detailed project management information comprising a plurality of hierarchical levels, hierarchical groups, activities, resources, and relationships, each activity belonging to a hierarchical level and a hierarchical group in the detailed project management information, each relationship defining a link between at least two activities, the activities and resources being distributed over a project time period;
transforming the detailed project management information into a WIT Source comprising a plurality of working level groups at a working level selected from the hierarchical levels in the detailed project management information, each working level group comprising an aggregation of activities from the hierarchical levels below the working level and depending from the hierarchical group corresponding to that working level group; and
manipulating the WIT Source to generate an alternate scenario differing from a baseline scenario associated with the detailed project management information and calculate a scenario outcome using the working level groups instead of the activities; and
reporting the scenario outcome.

2. The method of claim 1 characterized in that the act of transforming the detailed project management information into a WIT Source further comprises the acts of:
receiving a selection of a hierarchical level as a working level; and
receiving a selection of a working time unit.

3. The method of claim 2 characterized in that the act of transforming the detailed project management information into a WIT Source further comprises the acts of:
creating a temporal container for each working time unit within the project time period; and
distributing resources between the temporal containers based on a distribution of the resources in the detailed project management information.

4. The method of claim 2 characterized in that the detailed project management information further comprises a plurality of milestones, each milestone associated with an activity and having a due date, and in that the act of transforming the detailed project management information into a WIT Source further comprises the acts of:
linking each milestone to the working level group containing the activity associated with the milestone; and
assigning each milestone to the temporal container corresponding to the milestone due date.

5. The method of claim 4 characterized in that the working level has at least one of a start date and end date and in that the act of transforming the detailed project management information into a WIT Source further comprises the act of calculating an offset date for each milestone relative to one of the working level start date and the working level end date.

6. The method of claim 2 characterized in that the act of transforming the detailed project management information into a WIT Source further comprises the acts of:
associating information about each relationship from the detailed project management information to the working level groups containing the activities linked by that relationship;
identifying relationships linking activities aggregated into the same working level group as static relationships;
identifying relationships linking a first activity aggregated into a first working level group to a second activity aggregated into a second working level group as dynamic relationships; and
creating an intergroup relationship between the first working level group and the second working level group for each dynamic relationship.

7. The method of claim 6 further comprising the act of evaluating each relationship between each activity and the succeeding activity.

8. The method of claim 6 characterized in that each working level group has a start date, the method further comprising the acts of:
identifying a plurality of dynamic relationships forming a circular relationship between a plurality of working level groups that restrict the start dates of the plurality of working level groups from changing in relation to each other; and
locking the working level groups linked by the circular relationship together so that moving any of the circularly working level groups linked by the circular relationship moves all of the working level groups linked by the circular relationship.

9. The method of claim 6 further comprising the act of evaluating only the intergroup relationships when calculating a scenario outcome.

10. The method of claim 1 further comprising the act of exporting the alternate scenario.

11. The method of claim 10 characterized in that the act of exporting the alternate scenario further comprises the acts of:
calculating the differences between the scenario outcome for the alternate scenario and a baseline scenario outcome for the baseline scenario; and
modifying corresponding values in the detailed project management information to reflect the differences.

12. The method of claim 10 characterized in that the act of calculating the differences between the scenario outcome for the alternate scenario and a baseline scenario outcome for the baseline scenario further comprises the act of calculating offsets between start dates associated with the alternate scenario and start dates associated with the baseline scenario.

13. The method of claim 1 characterized in that the activities have one or more associated features and in that the act of transforming the detailed project management information into a WIT Source further comprises the act of organizing activities into feature groups based on a selected associated feature.

14. The method of claim 13 characterized in that the act of reporting the scenario outcome further comprises the acts of:
receiving a selection of a selected feature group; and
generating a report corresponding to the selected feature group.

15. The method of claim 1 characterized in that the act of transforming the detailed project management information into a WIT Source further comprises the act of linking reference data to the WIT Source.

16. A system for transforming detailed schedules specifying activities, resources, and relationships at various hierarchical levels in a project into summary schedules facilitating efficient evaluation of alternate scenarios, the system comprising:
a transform module operable to aggregate activities from the detailed schedules into working level groups at a working level selected from the plurality of hierarchical levels and generate working level group relationships corresponding to logical links between activities placed in different working level groups;
a manipulate module operable to generate an alternate scenario based on changes to a project constraint or project timeline supplied by a user and calculate an outcome for the alternate scenario using the working level groups and working level group relationships; and
a report module operable to display visualizations of the outcome.

17. The system of claim 16 characterized in that the detailed schedules specifying milestones having due dates and in that the transform module is further operable to create a timeline column for each working time unit between the start and end dates of the project, assign the resources to the timeline columns based on a distribution of the resources in the detailed schedules, and assign milestones to the timeline column encompassing the milestone due date.

18. The system of claim 16 characterized in that the detailed schedules specifying milestones and in that the transform module is further operable to assign information about relationships between activities to the working level groups containing the activities, assign the milestones to the working level group containing the activities associated with the milestones.

19. The system of claim 16 further comprising:
an import module operable to acquire the detailed schedules from an external project management tool in form usable by the transform module; and
an export module operable to update corresponding values schedules from an external project management tool in a form usable by the transform module.

20. A computer readable medium containing computer executable instructions which, when executed by a computer, perform a method for generating project scenarios and calculating scenario outcomes above the activity level of a project, the method comprising the acts of:
importing detailed schedules specifying activities, resources, and relationships from an external project management tool;
receiving a selection of a working level from a plurality of hierarchical levels associated with a project;
aggregate activities into working level groups at the working level;
creating intergroup relationships between working level groups based on relationships linking activities aggregated into different working level groups;
generate an alternate scenario based on changes to a project constraint or project timeline supplied by a user; and
calculating an outcome for the alternate scenario using the working level groups and working level group relationships; and
displaying visualizations of the outcome.
